(19) United States
(12) Patent Application Publication
(10) Pub. No.: US 2009/0195357 A1
(43) Pub. Date: Aug. 6, 2009

(54) Active transmission architecture without battery and application

(76) Inventors: Chun-Liang Tsai, Jhubei City (TW); Chang-Shao Chang, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,072

(22) Filed: Mar. 27, 2008

(30) Foreign Application Priority Data
Feb. 4, 2008 (TW) 097104233

(51) Int. Cl. H04Q 5/22; H04B 1/02

(52) U.S. Cl. 340/10.1; 455/91

(57) ABSTRACT

An active transmission architecture without battery and the application are proposed, which make use of an analog front-end circuit to convert a received carrier into a dc signal for providing power for the active transmission architecture without battery, and therefore actively produces a replying signal with the same or different frequencies from the carrier. It is not necessary to add an extra power circuit, hence accomplishing the advantage of no battery. The proposed active transmission architecture without battery can apply to RFID systems or be used in applications that require transmitter and receiver modules.

### BACKGROUND OF THE INVENTION

1. Field of the Invention

The present invention relates to a transmission architechture and the application thereof and, more particularly, to an active transmission architecture making use of an analog front-end circuit to convert ac signal to dc signal for the operation of transmitter and the application.

2. Description of Related Art

The wireless communication architecture requires a transmitter for emitting a carrier. An external dc power source is needed in the existent long-distance transmission applications.

In general, the wireless communication architecture can be divided into four categories. First, the transmitter needs a power source, and both of the transmitter and receiver use the same frequency for communication (e.g., a wireless mouse). Second, the transmitter needs a power source, and the transmitter and receiver use different frequencies for communication (e.g., dual-band mobile phones, wireless intercoms, and active RFID systems). Third, the transmitter needs no power source, and the transmitter and receiver use the same frequency for communication (e.g., passive RFID systems). The signal is returned by reflection of the carrier at the same frequency. Fourth, the transmitter needs no power source, and the transmitter and receiver use different frequencies for communication. There are no related applications yet. The primary reason is that a transmitter that actively transmits a signal generally consumes power to a certain degree and therefore needs a power source for its proper operations.

The communication architecture for an active RFID system can be also divided into two categories. First, the transmission and reception use the same frequency. Second, the transmission and reception use different frequencies. Whatever, the transmitter needs to be provided a power source or battery for the longer transmission distance. A conventional passive RFID system uses the same frequency for transmission and reception, and needs no battery for its proper actions. A passive RFID system is composed of a reader and at least one tag. As shown in FIG. 1, the reader comprises an antenna 10, a circulator 12, a transmitter 14, a receiver 16, a modulator 18, a demodulator 20, and a processor 22. As shown in FIG. 2, the tag comprises an antenna 24, an analog circuit 26, a digital circuit 28, a memory 30, and a MOS switch 32 for controlling reflection of signal. In existent passive RFID systems, the transmitter 14 in the reader emits a carrier of a certain band via the antenna 10 to the antenna 24 of the tag. After the tag receives the carrier, it converts this carrier into a dc signal via the analog circuit to drive the circuits in the tag. The tag then controls the MOS switch 32 to reply a signal to the reader by means of backscattering. Next, the replied signal is received by the antenna 10 of the reader, and then passes the circulator 12 to enter the receiver 16. Finally, the replied signal of the tag is demodulated. This is the principle of the passive RFID system. In this passive backscattering manner, because the carrier frequency of the tag to the reader is the same as the frequency transmitted by the reader, there exists the problem of co-channel interference at the receiving end of the reader. That is, when the transmitting end of the reader transmits a carrier to the tag, the receiving end of the reader will also receive part of this transmitted carrier. Mixed with the replying signal of the same frequency reflected by the tag, the problem of co-channel interference arises. Generally speaking, to solve the problem of co-channel interference, a circulator with isolation effect is added between the transmitting end and receiving end of the reader. The isolation is about 20˜30 dB. However, the cost of the RFID reader is raised because of using the circulator. The replying signal of the tag is very weak compared with the reader's transmitted carrier that is received at the receiving end of the reader. If the reader transmits a signal with a power of 1 watt (30 dBm) and the isolation of the circulator is 22 dB, then the receiving end of the reader will receive a signal with a power of 8 dBm. In the situation that the reader and the tag are separated by 6 meters, the replying signal of the tag to the reader has a power of only −50 dBm. In addition to the problem of co-channel interference, the dynamic range at the receiving end of the reader must be higher to demodulate this weak replying signal from the tag, which makes the circuit design of the receiving end more complicated and difficult.

Accordingly, the present invention aims to propose an active transmission architecture without battery and the application so as to solve the above problems in the prior art.

### SUMMARY OF THE INVENTION

An object of the present invention is to provide an active transmission architecture without battery and the application, which is powered by an analog front-end circuit through the conversion of a carrier received by the analog front-end circuit.

Another object of the present invention is to provide an active transmission architecture without battery and the application, which has a longer transmission distance and no battery.

Yet another object of the present invention is to provide an active transmission architecture without battery and the application, which can produce a replying signal with a different frequency from the carrier transmitted by the reader to avoid the problem of mutual interference and thus reduce the sensitivity required by the receiver in the reader, thereby lowering the cost of the reader.

Still yet another object of the present invention is to provide an active transmission architecture without battery and the application, which can be applied to RFID systems or be used in other applications that require transmitter and receiver modules.

To achieve the above objects, the present invention provides an active transmission architecture without battery powered by an analog front-end circuit through the conversion of a carrier that is received by the analog front-end circuit.

The present invention also provides a tag architecture of an RFID system making use of active transmission architecture without battery. The tag architecture includes an analog front-end circuit and a transmitter without battery powered by an analog front-end circuit through the conversion of a carrier that is received by the analog front-end circuit.

The present invention further provides a transmitter module that makes use of transmitter without battery. The transmitter module includes an analog front-end circuit and a transmitter without battery powered by the analog front-end circuit through the conversion of a carrier that is received by the analog front-end circuit.

### BRIEF DESCRIPTION OF THE DRAWINGS

The various objects and advantages of the present invention will be more readily understood from the following detailed description when reading in conjunction with the appended drawing, in which:

FIG. 1 is an architecture block diagram of a conventional reader;

FIG. 2 is an architecture block diagram of a conventional tag;

FIG. 3 is a diagram showing how a transmitter without battery is applied in a tag architecture according to an embodiment of the present invention; and

FIG. 4 is an operation flowchart of the tag architecture of FIG. 3 collocated with a reader.

### DETAILED DESCRIPTION OF THE PREFERRED EMBODIMENTS

The present invention is characterized in that an analog front-end circuit capable of converting an ac carrier to a dc signal is used to provide power for an active transmitter without battery so as to form a communication architecture. Those of ordinary skill in the art can further apply this communication architecture to RFID systems or use this communication architecture in other applications that require transmitter and receiver modules.

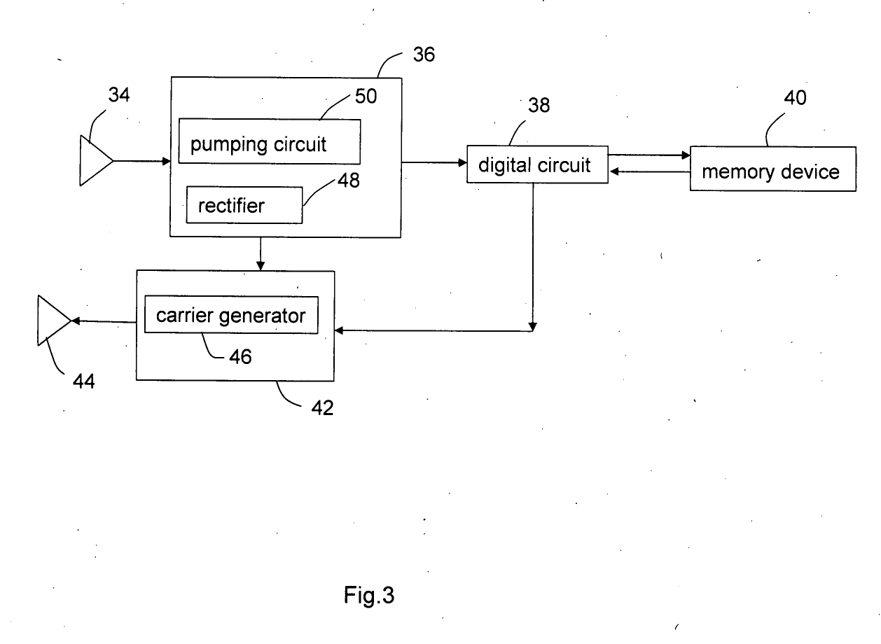

FIG. 3 is a diagram showing how an active transmitter without battery powered by the analog front-end circuit of the present invention is applied in a tag architecture. As shown in FIG. 3, the tag architecture comprises a first antenna 34, an analog front-end circuit 36, a digital circuit 38, a memory device 40, an active transmitter without battery 42, and a second antenna 44. The first antenna 34 is used to receive a first carrier. The analog front-end circuit 36 is used to receive the first carrier that is received by the first antenna 34 and convert this ac carrier to a dc signal through rectification and pumping. The digital circuit 38 receives the dc signal from the analog front-end circuit 36. The memory device 40 used in the transmission architecture is electrically connected to the digital circuit 38, and stores operational data of the system for access of the digital circuit 38. The active transmitter without battery 42 is electrically connected to the digital circuit 38 and the analog front-end circuit 36 and is used to receive a signal from the digital circuit 38, and is driven by the analog front-end circuit 36 to produce a second carrier. The second antenna 44 is used to emit the second carrier.

The active transmitter without battery 42 of the present invention includes a carrier generator 46, which produces a carrier of a specific frequency according to the actions of the analog front-end circuit 36 and the digital circuit 38. The analog front-end circuit 36 includes a rectifier 48 and a pumping circuit 50, which are used to accomplish the object of converting ac carrier to dc signal.

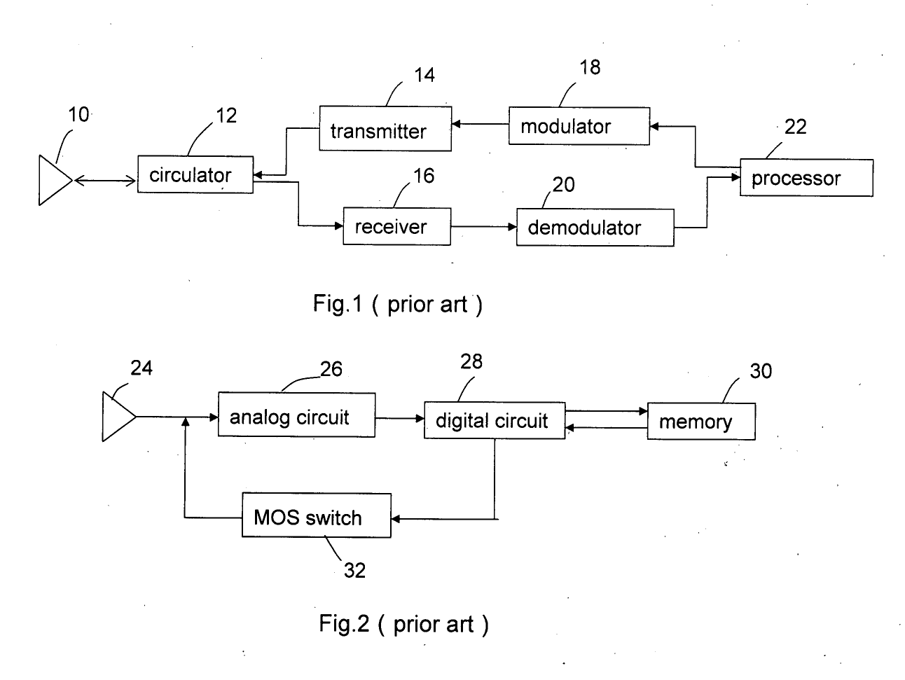

The architecture of the reader is shown in FIG. 1. Since this is a well-known art, a detailed explanation thereof will be omitted

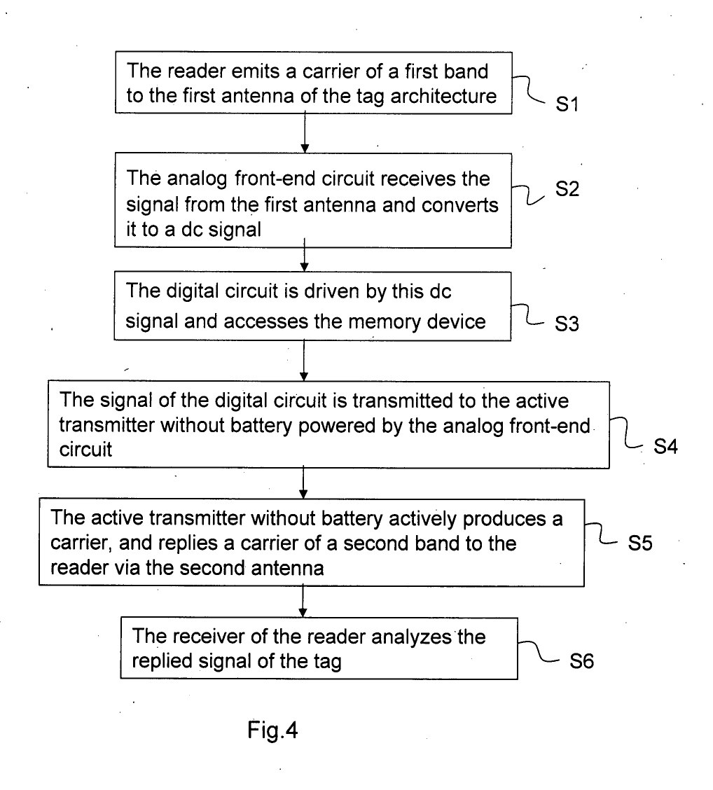

FIG. 4 is an operation flowchart of the tag architecture of FIG. 3 collocated with a reader. Reference is made to FIGS. 1, 3 and 4. First, the reader emits a carrier of a first band to the first antenna 34 of the tag architecture of the present invention shown in FIG. 3 (Step S1). Next, analog the front-end circuit 36 receives the signal from the first antenna 34 and converts it to a dc signal (Step S2). Subsequently, the digital circuit 38 is driven by this dc signal and accesses the memory device 40 (Step S3). The signal of the digital circuit is then transmitted to the active transmitter without battery 42 powered by the analog front-end circuit 36 (Step S4). Next, the active transmitter without battery 42 actively produces a carrier, and replies a carrier of a second band to the reader via the second antenna 44 (Step S5). Finally, the receiver of the reader analyzes the replied signal of the tag (Step S6).

In the above embodiment, the present invention is illustrated with a reader having a single antenna. For those of ordinary skill in the art certainly know that the tag architecture of the present invention can also be collocated with a reader having dual antennas respectively for transmission and reception.

Moreover, the frequencies of the carrier of the second band replied by the tag adopting the active transmitter without battery 42 powered by the analog front-end circuit 36 and the carrier transmitted by the reader can be the same or different according to practical demands. For instance, the frequency of the carrier transmitted by the reader and received by the tag is 433 MHz, but the frequency of the carrier transmitted by the tag is 315 MHz.

To sum up, the present invention provides an active transmission architecture without battery and the application to achieve the effect of automatic reply without battery. When applied to RFID systems, the present invention has a longer transmission distance as compared to conventional active ones and also has no battery. Moreover, when the frequencies of the carrier replied by the tag adopting the active transmitter without battery powered by the analog front-end circuit and the carrier transmitted by the reader are different, the replied signal of the tag received by the receiving end of the reader won't be interfered with the carrier of the reader, hence solving the problem of co-channel interference occurred in the conventional passive RFID systems. Because of no co-channel interference, the dynamic range requirement of the receiver of the reader can be substantially reduced, hence lowering the cost of reader. Furthermore, because the tag actively transmits a replying signal through another band to the reader after converting the carrier of the reader to a dc signal for driving the internal circuits thereof and the frequencies of the replied signal and the signal transmitted by the reader are different, the tag architecture of the present invention has a longer replying distance as compared to conventional ones adopting the same frequency for transmission and reception under the same transmission power conditions.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. An active transmission architecture without battery powered by an analog front-end circuit through the conversion of a carrier that is received by said analog front-end circuit.

2. The active transmission architecture without battery as claimed in claim 1, wherein said active transmitter includes a carrier generator.

3. The active transmission architecture without battery as claimed in claim 1, wherein said analog front-end circuit includes a rectifier used to convert said received carrier into a dc signal.

4. The active transmission architecture without battery as claimed in claim 3, wherein said rectifier is further electrically connected to a pumping circuit for the pumping of said dc signal.

5. The active transmission architecture without battery as claimed in claim 1, wherein said active transmitter without battery can be applied in the tag of an RFID system.

6. The active transmission architecture without battery as claimed in claim 5, wherein said RFID system further comprises:
a digital circuit for receiving a signal of said analog front-end circuit and driving said active transmitter without battery to transmit a replying signal;
a first antenna for receiving said carrier and sending to said analog front-end circuit; and
a second antenna for transmitting said replying signal.

7. The active transmission architecture without battery as claimed in claim 6, wherein said RFID system further includes a memory electrically connected to said digital circuit.

8. The active transmission architecture without battery as claimed in claim 6, wherein the frequency of said carrier is different from that of said replying signal.

9. The active transmission architecture without battery as claimed in claim 6, wherein the frequency of said carrier is the same as that of said replying signal.

10. The active transmission architecture without battery as claimed in claim 6, wherein said active transmitter includes a carrier generator.

11. The active transmission architecture without battery as claimed in claim 10, wherein said carrier generator bases on said analog front-end circuit and said digital circuit to produce a carrier with a specific frequency.

12. A tag architecture of an RFID system making use of active transmitter without battery, said tag architecture comprising:
an analog front-end circuit; and
an active transmission architecture without battery powered by said analog front-end circuit through the conversion of a carrier that is received by said analog front-end circuit.

13. The tag architecture as claimed in claim 12, wherein said active transmitter includes a carrier generator.

14. The tag architecture as claimed in claim 12, wherein said analog front-end circuit includes a rectifier used to convert said received carrier into a dc signal.

15. The tag architecture as claimed in claim 14, wherein said rectifier is further electrically connected to a pumping circuit for the pumping of said dc signal.

16. The tag architecture as claimed in claim 12, wherein said tag architecture further comprises:
a first antenna for receiving said carrier and sending to said analog front-end circuit;
a digital circuit for receiving a signal of said analog front-end circuit and driving said active transmitter without battery to transmit a replying signal; and
a second antenna for transmitting said replying signal.

17. The tag architecture as claimed in claim 16, wherein said tag architecture further includes a memory electrically connected to said digital circuit.

18. The tag architecture as claimed in claim 16, wherein the frequency of said carrier is different from that of said replying signal.

19. The tag architecture as claimed in claim 16, wherein the frequency of said carrier is the same as that of said replying signal.

20. The tag architecture as claimed in claim 16, wherein said active transmitter includes a carrier generator.

21. The tag architecture as claimed in claim 20, wherein said carrier generator bases on said analog front-end circuit and said digital circuit to produce a carrier with a specific frequency.

22. The tag architecture as claimed in claim 16, wherein a reader corresponding to said tag architecture of an RFID system comprises:
a receiver;
a transmitter; and
an antenna for receiving a first RF carrier of a first band and sending to said receiver and transmitting a second RF carrier of a second band that is transmitted by said transmitter.

23. The tag architecture as claimed in claim 16, wherein a reader corresponding to said tag architecture of an RFID system comprises:
a receiver;
a transmitter;
a first antenna for receiving a first RF carrier of a first band and sending to said receiver; and
a second antenna for transmitting a second RF carrier of a second band that is transmitted by said transmitter.

24. The tag architecture as claimed in claim 22, wherein said first band and said second band are the same.

25. The tag architecture as claimed in claim 23, wherein said first band and said second band are the same.

26. The tag architecture as claimed in claim 22, wherein said first band and said second band are different.

27. The tag architecture as claimed in claim 23, wherein said first band and said second band are different.

28. A transmitter module making use of active transmitter without battery, said transmitter module comprising:
an analog front-end circuit; and
an active transmitter without battery powered by said analog front-end circuit through the conversion of a carrier that is received by said analog front-end circuit.

29. The transmitter module as claimed in claim 28, wherein said active transmitter without battery includes a carrier generator.

30. The transmitter module as claimed in claim 28, wherein said analog front-end circuit includes a rectifier used to convert said received carrier into a dc signal.

31. The transmitter module as claimed in claim 30, wherein said rectifier is further electrically connected to a pumping circuit for the pumping of said dc signal.

32. The transmitter module as claimed in claim 28, wherein said transmitter module further comprises:
a first antenna for receiving said carrier and sending to said analog front-end circuit;
a digital circuit for receiving a signal of said analog front-end circuit and driving said active transmitter without battery to transmit a replying signal; and
a second antenna for transmitting said replying signal.

33. The transmitter module as claimed in claim 32, wherein said transmitter module further includes a memory electrically connected to said digital circuit.

34. The transmitter module as claimed in claim 32, wherein the frequency of said carrier is different from that of said replying signal.

35. The transmitter module as claimed in claim 32, wherein the frequency of said carrier is the same as that of said replying signal.

36. The transmitter module as claimed in claim 32, wherein said active transmitter includes a carrier generator.

37. The transmitter module as claimed in claim 36, wherein said carrier generator bases on said analog front-end circuit and said digital circuit to produce a carrier with a specific frequency.

38. The transmitter module as claimed in claim 28, wherein said transmitter module further comprises a receiver module for receiving a signal of said transmitter module, and said receiver module comprises:
a receiver;
a transmitter; and
an antenna for receiving a first RF carrier of a first band and sending to said receiver and transmitting a second RF carrier of a second band that is transmitted by said transmitter.

39. The transmitter module as claimed in claim 28, wherein said transmitter module further comprises a receiver module for receiving a signal of said transmitter module, and said receiver module comprises:
a receiver;
a transmitter;
a first antenna fore receiving a first RF carrier of a first band and sending to said receiver; and
a second antenna for transmitting a second RF carrier of a second band that is transmitted by said transmitter.

40. The transmitter module as claimed in claim 38, wherein said first band and said second band are the same.

41. The transmitter module as claimed in claim 39, wherein said first band and said second band are the same.

42. The transmitter module as claimed in claim 38, wherein said first band and said second band are different.

43. The transmitter module as claimed in claim 39, wherein said first band and said second band are different.
